(19) United States
(12) Patent Application Publication
(10) Pub. No.: US 2011/0248002 A1
(43) Pub. Date: Oct. 13, 2011

(54) PLASMA GENERATION APPARATUS

(75) Inventors: Adnan Kutubuddin Bohori, Bangalore (IN); Thangavelu Asokan, Bangalore (IN); Govardhan Ganireddy, Bangalore (IN)

(73) Assignee: GENERAL ELECTRIC COMPANY, Schenectady, NY (US)

(21) Appl. No.: 12/759,049

(22) Filed: Apr. 13, 2010

(51) Int. Cl. B23K 10/00

(52) U.S. Cl. 219/121.5; 219/121.36

(57) ABSTRACT

Provided is an apparatus, such as an arc mitigating device, that includes an annular body that defines a lumen and a longitudinal axis, the annular body having a body length along the longitudinal axis. An electrode can be disposed coaxially within the lumen. The electrode may extend into the body by an electrode length that is at least about 50% of the body length, and may have diameter less than or equal to about 50% of an inner diameter of the annular body. An ablative material portion can be disposed between the annular body and the electrode. The annular body and the electrode may be configured such that when an arc exists between the annular body and the electrode, the ablative material portion undergoes ablation and thereby generates a plasma.

### BACKGROUND

Embodiments presented herein generally relate to plasma guns, and more particularly to ablative plasma guns.

Electric power circuits and switchgear typically involve conductors separated by insulation. Air space often serves as part or all of this insulation in some areas. If the conductors are too close to each other or the voltage difference exceeds the insulation properties, an arc can occur between the conductors. Air or any insulation (gas or solid dielectrics) between the conductors can become ionized, making the insulation conductive and thereby enabling arcing. Arc temperatures can reach as high as 20,000° C., vaporizing conductors and adjacent materials, and releasing an explosive energy that can destroy circuits.

Arc flash is the result of a rapid energy release due to an arcing fault between phase-phase, phase-neutral, or phase-ground. An arc flash can produce high heat, intense light, pressure waves, and sound/shock waves similar to that of an explosion. However, the arc fault current is usually much less in magnitude as compared to short circuit current, and hence delayed or no tripping of circuit breakers is expected unless the breakers are selected to handle an arc fault condition. Typically, arc flash mitigation techniques use standard fuses and circuit breakers. However, such techniques have slow response times and may not be fast enough to mitigate an arc flash.

One other technique that has been used to mitigate arc fault is to employ a shorting (mechanical crowbar) switch, placed between the power bus and ground, or between phases. Upon occurrence of an arc fault, the crowbar switch shorts the line voltage on the power bus and diverts the energy away from the arc flash, thus protecting equipment from damage due to arc blasts. The resulting short on the power bus causes an upstream circuit breaker to clear the bolted fault. Such switches, which are large and costly, are located on the main power bus causing the bolted fault condition when triggered. As a result, the mechanical crowbars are known to cause extreme stress on upstream transformers.

There is a need for improved arc flash prevention mechanism that has an improved response time and that is cost effective.

### BRIEF DESCRIPTION

In one aspect, an apparatus, such as an arc mitigating device, is provided. The apparatus can include an annular body that defines a lumen and a longitudinal axis, which annular body can have a body length along the longitudinal axis. An electrode can be disposed coaxially within the lumen. The electrode may extend into the body by an electrode length that is at least about 50% of the body length, and may have diameter less than or equal to about 50% of an inner diameter of the annular body. The electrode can include a main region and an initiation region, at least part of said initiation region being disposed closer than said main region to said annular body. In some embodiments, the annular body can include opposing first and second ends, with the electrode extending into the annular body from the first end and a nozzle disposed at the second end.

An ablative material portion can be disposed between the annular body and the electrode. The ablative material portion can be disposed along an inner wall of the annular body, for example, being disposed over about 50% to about 90% of the inner wall. The ablative material portion can include an ablative material, such as, for example, polytetrafluoroethylene, polyoxymethylene polyamide, and/or poly-methyle methacralate.

In some embodiments, the annular body and electrode may be integrated into a plasma generation device. The apparatus can further include a main electrode, wherein said plasma generation device is separated from said main electrode by at least about 30 mm and is configured to emit plasma so as to generally occupy a space between said plasma generation device and said main electrode.

The annular body and said electrode may be configured to be charged as one and the other of a cathode and an anode. An energy source can be connected to and configured to sustain an arc between the annular body and the electrode. In one embodiment, the energy source can be configured to produce a voltage less than or equal to about 1 kV and a current of at least about 4 kA. The annular body and the electrode may be configured such that when an arc exists between the annular body and the electrode, the ablative material portion undergoes ablation and thereby generates a plasma.

In another aspect, an apparatus, such as an arc mitigating device, is provided. The apparatus can include a plasma generation device including an annular body that defines a lumen and a longitudinal axis. The annular body can have a body length along the longitudinal axis. An electrode can be disposed coaxially within the lumen, extending into the body by an electrode length that is at least about 50% of the body length. An ablative material portion can disposed between the annular body and the electrode.

An energy source can be connected to the annular body and the electrode. The energy source can be configured to sustain an arc between the annular body and the electrode, producing a voltage less than or equal to about 1 kV and a current of at least about 4 kA. When an arc exists between the annular body and the electrode, the ablative material portion may undergo ablation due to the arc, thus generating a plasma.

The plasma generation device may be separated from a main electrode by at least about 30 mm. The plasma generation device may be configured to emit plasma so as to generally occupy a space between the plasma generation device and the main electrode. The apparatus may also include a second plasma generation device and two main electrodes that are separated from one another by at least about 50 mm. The plasma generation device and the second plasma generation device can each be disposed substantially between the main electrodes and configured to provide a plasma bridge between the main electrodes.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic view of an electrical power system configured in accordance with an example embodiment;

FIG. 2 is a perspective view of the arc mitigating device of FIG. 1;

FIG. 3 is a perspective view of the plasma generation system of FIG. 2;

FIG. 4 is a perspective, partially exploded view of the plasma generation system of FIG. 2;

FIG. 5 is a cross sectional view of the plasma gun of FIG. 3 taken along the plane labeled with the reference numeral 5 in FIG. 3;

FIG. 6 is a cross sectional view of the plasma gun of FIG. 3 taken along the plane labeled with the reference numeral 6 in FIG. 3;

FIG. 7 is a circuit diagram of the plasma generation system of FIG. 2;

FIG. 8 is a circuit diagram of the plasma generation system of FIG. 2 depicting the formation of respective arcs between the annular bodies and corresponding electrodes of the plasma guns;

FIG. 9 is a circuit diagram of the plasma generation system of FIG. 2 depicting the generation of plasma in the plasma guns;

FIG. 10 is a schematic side view depicting the operation of the arc mitigating device of FIG. 2;

FIG. 11 is a schematic side view of the arc mitigating device of FIG. 2

FIG. 12 is a perspective view of a plasma generation system configured in accordance with another example embodiment; and

FIG. 13 is a schematic side view of an arc mitigating device including the plasma generation system of FIG. 12.

### DETAILED DESCRIPTION

Example embodiments are described below in detail with reference to the accompanying drawings, where the same reference numerals denote the same parts throughout the drawings. Some of these embodiments may address the above and other needs.

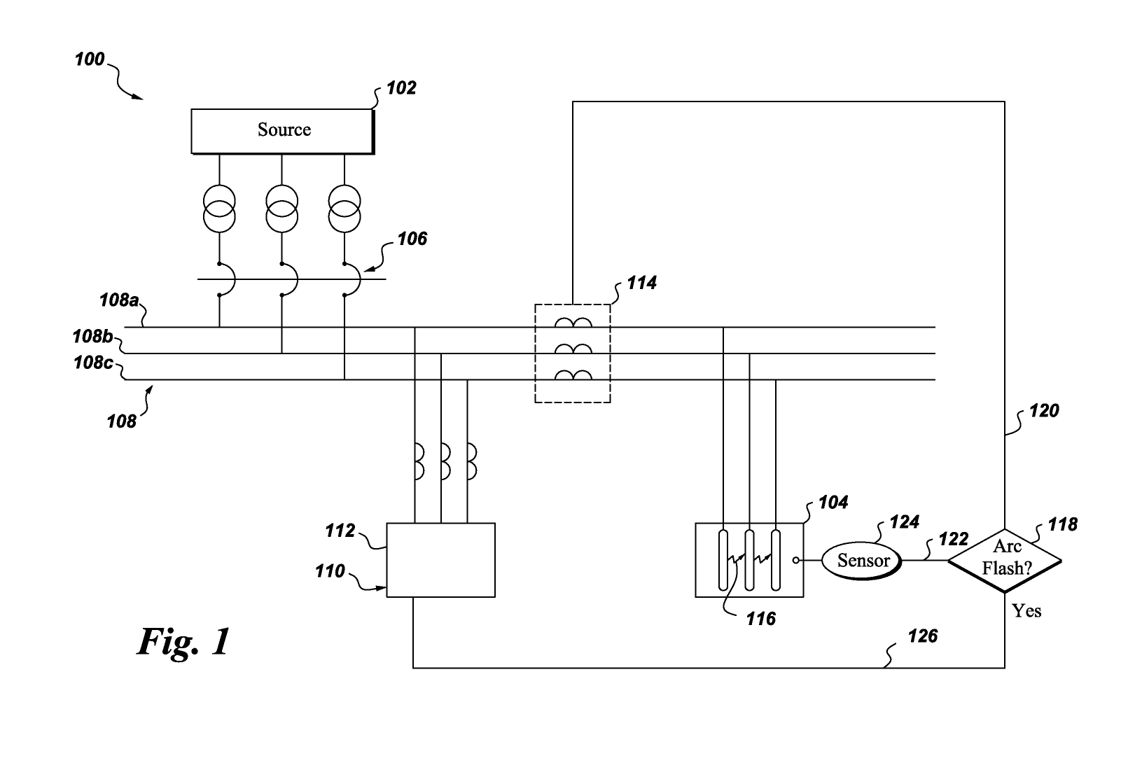

Referring to FIG. 1, an electrical power system is illustrated and designated generally by the reference numeral 100. The electrical power system 100 includes a power source 102 configured to deliver power to a load 104 via a circuit breaker 106. For example, the power source 102 can deliver alternating current (AC) power to a common bus 108 using a three-phase configuration, as shown, or, for example, via a single phase configuration. The power source 102 and the load 104 can also be coupled, via the common bus 108, to an arc mitigating device 110. The arc mitigating device 110 can be enclosed within an arc containment device 112.

An electrical signal monitoring system 114 can be configured to monitor current variations in the electrical power system 100 that may arise due to an arc flash event 116. In one example, the electrical signal monitoring system 114 includes a current transformer. An arc flash decision system 118 can be configured to receive electrical parameters 120 from the electrical signal monitoring system 114 and parameters 122 from an arc flash sensor 124. As used herein, the term ‘parameters’ refers to indicia of arc flash events such as, for example, optical light, thermal radiation, acoustic, pressure, and/or radio frequency signals originating from an arc flash event 116. Accordingly, the sensor 124 can include, for example, an optical sensor, a thermal radiation sensor, an acoustic sensor, a pressure transducer, and/or radio frequency sensor. Based on the parameters 120 and 122, the arc flash decision system 118 can generate an arc fault signal 126 indicating the occurrence of the arc flash event 116. As discussed below, the arc fault signal 126 may serve to activate the arc mitigating device 110.

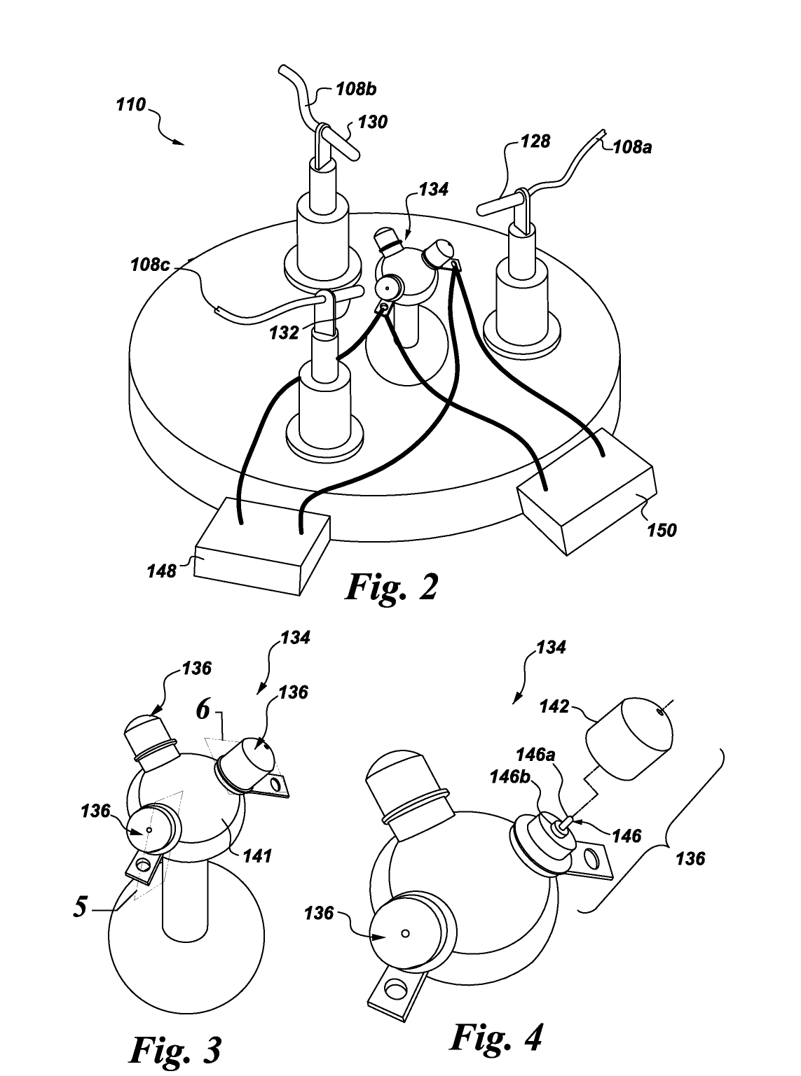

Referring to FIGS. 1 and 2, the arc mitigating device 110 can include main electrodes 128, 130, 132 respectively connected to the conductors 108a, 108b, 108c of the common bus 108 (the different conductors corresponding, for example, to different phases, neutral, or ground). While this embodiment shows three main electrodes, other embodiments may include more or fewer electrodes as required by the electrical power system. Clearance between the main electrodes 128, 130, 132 may be required for normal operation of the electrical power system 100, with the requisite amount of clearance depending on the system voltage. For example, a low voltage system operating at about 600 V may require a clearance of about 25-30 mm between the main electrodes 128, 130, 132, while a medium voltage system operating at about 15 kV may require the main electrodes to be separated by at least about 50 mm, and in some cases more than 100 mm or even 150 mm.

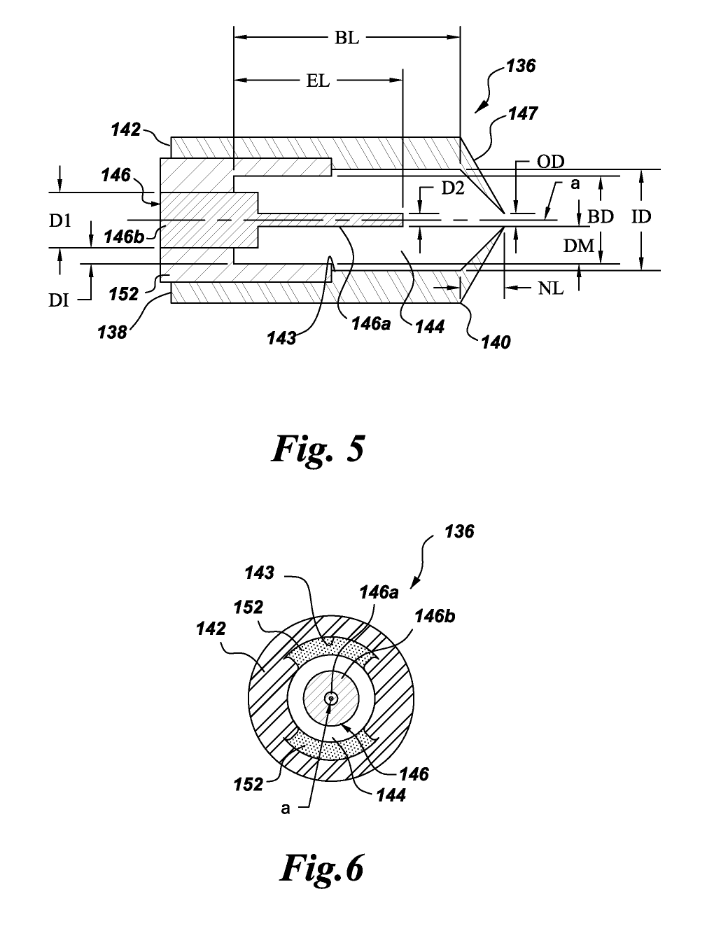

Referring to FIGS. 1-6, the arc mitigating device 110 can include a plasma generation system 134. The plasma generation system 134 can include one or more plasma generation devices, such as plasma guns 136, that are supported by a housing 141 and disposed between the main electrodes 128, 130, 132. Each of the plasma guns 136 can include a respective annular body 142. Each annular body 142 can define a respective lumen 144, say, that is defined by an inner wall 143 of the respective annular body. Each annular body 142 can have an inner body diameter BD, and can define a longitudinal axis a along which each annular body can have a body length BL. The annular bodies 142 can be formed, for example, of copper and/or stainless steel, and may include terminals to facilitate electrical connection thereto.

Each of the plasma guns 136 can also include an electrode 146, which may also be formed, for example, of copper and/or stainless steel, and may also include terminals to facilitate electrical connection thereto. The electrodes 146 can be disposed within a corresponding lumen 144 so as to be coaxial with the associated annular body 142. Each electrode 146 can extend into a respective body 142 by an electrode length EL. Each electrode 146 can include a main region 146a and an initiation region 146b. The initiation region 146b can be disposed closer than the main region 146a to the annular body 142, such that a distance D1 between the initiation region and the annular body is smaller than a distance DM between the main region and the annular body. For example, the initiation region 146b can be a cylinder of a first diameter D1, and the main region can be a cylinder extending from the initiation region and having a second diameter D2 that is smaller than D1, such that a sharp change in geometry is seen when moving between the initiation region and the main region.

Each of the plasma guns 136 can also include a nozzle 147. For example, each annular body 142 can include opposing first and second ends 138, 140, with the electrode 146 extending into the annular body from the first end and the nozzle 147 disposed at the second end. The nozzle 147 can have a nozzle length NL, an inlet diameter ID and an outlet diameter OD.

One or more ablative material portions 152 can be disposed between each annular body 142 and a corresponding electrode 146. For example, the ablative material portions 152 can include dielectric materials disposed along an inner wall 143 of the respective annular body 142. As discussed further below, the ablative material portions 152 can be configured such that at least one ablative material portion 152 will be ablated when an arc of sufficient current exists between a corresponding annular body and electrode pair 142 and 146. Candidate ablative materials include, for example, polytetrafluoroethylene, polyoxymethylene polyamide, poly-methyle methacralate (PMMA), and/or other ablative polymers.

The inner body diameter BD may be in the range from about 4 mm to about 6 mm, and the body length BL may be in the range from about 5 mm to about 10 mm. The electrode length EL may be in the range from about 50% to about 100% of BL, with any where from 75% to 95% of EL being consumed by the main region 146a. The electrode diameters D1 and D2 can be in the ranges from 0.5 to 1 mm and from 1 to 2 mm, respectively. In some embodiments, the electrode length EL may be at least about 50% of the body length BL, while in other embodiments EL may be 75% or even 100% of BL. In some embodiments, the diameter D2 of the electrode 146 can be less than or equal to about 50% of the inner diameter BD of the annular body 142, and in some embodiments less than or equal to one third of BD. Further, the ablative material portion 152 can, in some cases, be disposed over at least 50% to about 90% of the inner wall 143.

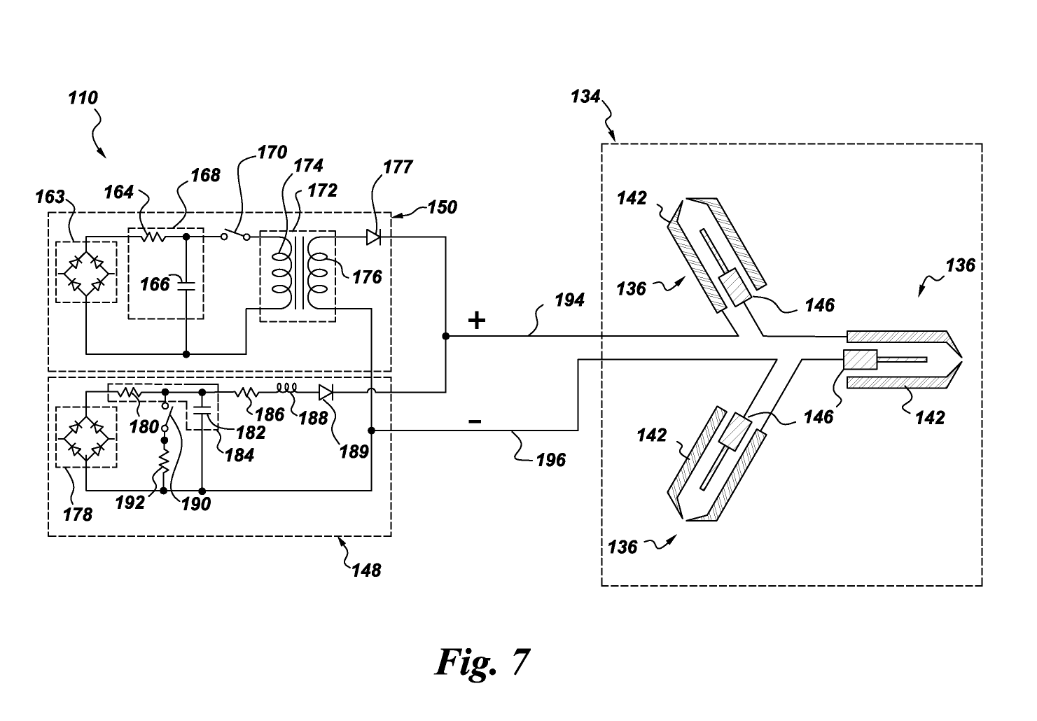

Referring to FIGS. 2-7, the arc mitigating device 110 can also include a low voltage, high current pulse energy source 148. In this context, “low voltage, high current” pulse energy source refers to an energy source that is configured to produce a voltage less than or equal to about 1 kV and a pulse current of at least about 4 kA. The low voltage, high current pulse energy source 148 can be configured such that, when an arc exists between a corresponding annular body 142 and electrode 146, the current associated with the arc is sufficient to ablate at least one ablative material portion 152. An example of a low voltage, high current pulse energy source 148 is provided below.

The low voltage, high current pulse energy source 148 may be, for example, a capacitive discharge circuit using a microfarad range capacitor that generates relatively high current and relatively low voltages (e.g., approximately 4-5 kA at a voltage lower than approximately 1 kV). The low voltage, high current pulse energy source 148 can include a rectifier 178 in power connection with a power source (not shown), and a resistor 180 and a capacitor 182 configured as a resistive-capacitive charging circuit 184. For example, the low voltage, high current pulse energy source 148 can receive a voltage of approximately 480 VAC from a power source (not shown), and the capacitor 182 can charge up to approximately 600 V. Additionally, a switch 190 and resistor 192 can be connected in series across the rectifier 178 to provide a discharge path during testing of the low voltage, high current pulse energy source 148.

The plasma guns 136 can be connected to one another in series, with the electrode 146 of one gun being connected to the annular body 142 of a subsequent gun. The low voltage, high current pulse energy source 148 can connect via the conductor 194, and through a resistor 186, an inductor 188, and a diode 189, to the annular body 142 of the plasma gun 136 that is first in the series, and via the conductor 196 to the electrode 146 of the plasma gun that is last in the series. In this way, the capacitor 182 can be connected in parallel with the series of plasma guns 136.

A high voltage, low current pulse energy source 150 can also be connected across the series of plasma guns 136, and can be configured to generate an at least transient potential difference sufficient to cause breakdown of air between each annular body-electrode pair 142, 146. In this context, “high voltage, low current” pulse energy source refers to an energy source that is configured to produce a voltage of at least about 8 kV and a pulse current less than or equal to about 1 A. An example of a high voltage, low current pulse energy source 150 is provided below.

The high voltage, low current pulse energy source 150 may be a capacitor discharge circuit or a pulse transformer-based, for example. The high voltage pulse energy source 150 can include a rectifier 163 in power connection with a power source (not shown), a resistor 164 and a capacitor 166 forming a resistive-capacitive charging circuit 168, and a switch 170 disposed in series with the capacitor 166. For example, the high voltage, low current pulse energy source 150 can receive a voltage of approximately 120-480 V AC (120-480 VAC), and the capacitor 166 can charge to a predetermined voltage of approximately 240 V. The high voltage, low current pulse energy source 150 can further include a high voltage pulse transformer 172 having a primary winding 174 and a secondary winding 176. The primary winding 174 can be in power connection with the power source (not shown) through the switch 170 and the secondary winding 176 can be in power connection, through a diode 177, with the conductor 194 that connects to the first of the series of plasma guns 136 and also with the conductor 196 that connects to the last of the series.

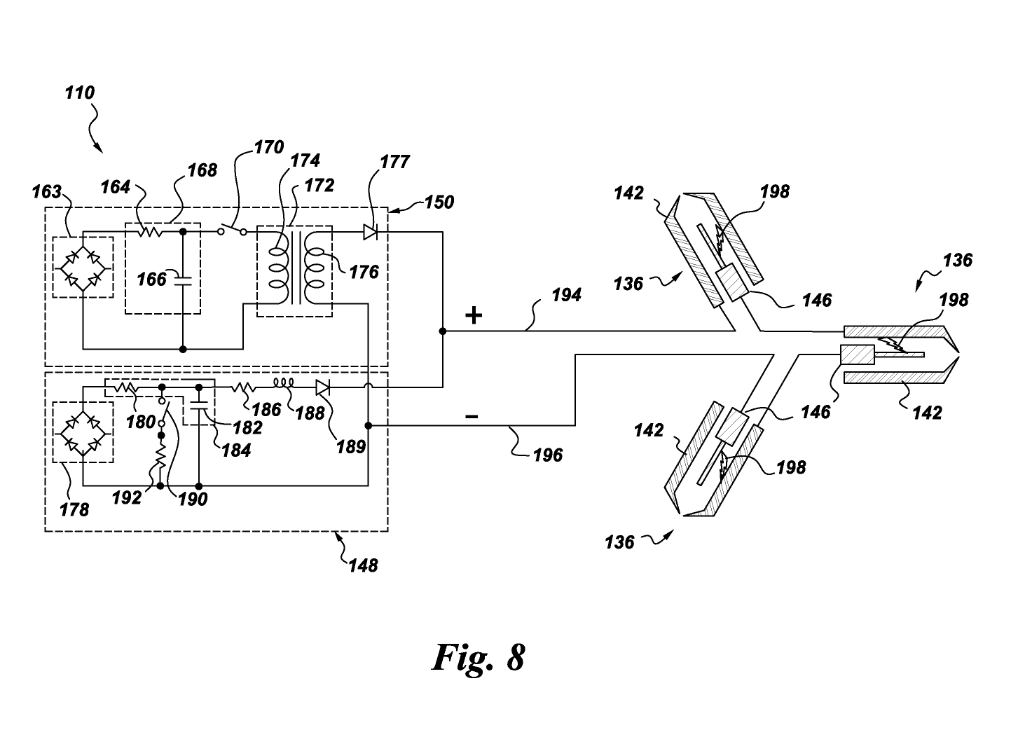

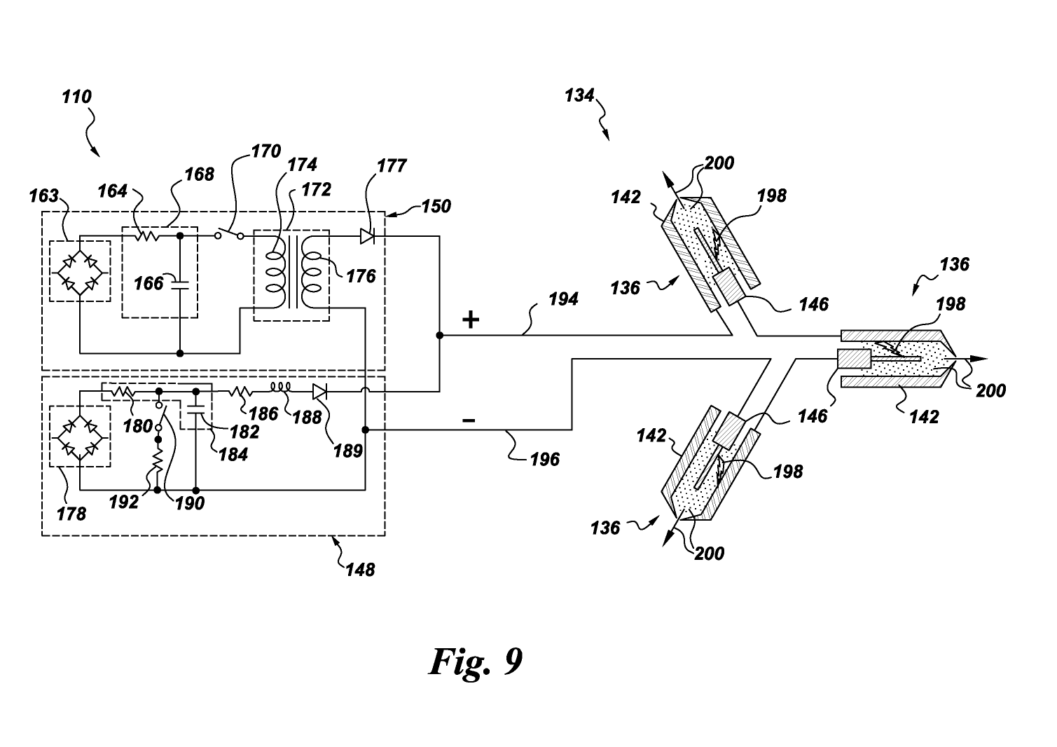

Referring to FIGS. 1 and 7-9, in operation, the arc flash decision system 118 can determine the occurrence of an arc flash event 116 (based on the parameters 120 and 122) and generate an arc fault signal 126. The high voltage, low current pulse energy source 150 can be configured to receive the arc fault signal 126 and to generate, in response, a pulse that causes a breakdown of air (or, more generally, whatever gas is present) between each annular body 142 and opposing electrode 146. For example, the arc fault signal 126 may cause the switch 170 to close, with a pulse being sent through the primary winding 174 of the pulse transformer 172. In response, a second voltage potential may be established via the secondary winding 176 of the transformer 172 across each annular body-electrode pair 142, 146. Thus, a high voltage (e.g., approximately 8 kV when the capacitor 166 is charged to approximately 240 V), low current pulse can be created.

The high voltage, low current pulse acts to charge the annular body 142 and the electrode 146 as an anode and a cathode, respectively (or vice versa in some embodiments), which pulse may be high enough to overcome the breakdown voltage of air between each annular body 142 and opposing electrode 146. As a result, an arc 198 of relatively low energy may span the distance between each annular body 142 and the opposing electrode 146. The diodes 177, 189 may act to prevent the high voltage, low current pulse from bypassing some of the plasma guns 136, for example, by following a path through the capacitor 182.

Initiation of the arc 198 between each annular body 142 and the opposing electrode 146 may be facilitated by the presence of the initiation region 146b of the electrode 146. The initiation region 146b, being disposed closer than the main region 146a to the annular body 142, may allow for initiation of the arc 198 at lower voltages and/or more reliable initiation of the arc. Further, where there is a sharp change in geometry between the main region 146a and the initiation region 146b, the electric field between the annular body 142 and the opposing electrode 146 may be stronger, which may lead to a decrease in the voltage required to initiate the arc 198.

The presence of the arc 198 between the electrode 146 and the annular body 142 may cause a decrease in the impedance presented by the space therebetween. This decrease in impedance may be sufficient to allow the arc 198 to be sustained between the electrode 146 and the annular body 142 under the influence of the low voltage, high current pulse energy source 148. The decrease in impedance also allows a high current pulse to flow between the electrode 146 and the annular body 142 despite the low voltage. The energy of the arc 198 therefore increases significantly as the capacitor 182 of the low voltage, high current pulse energy source 148 discharges.

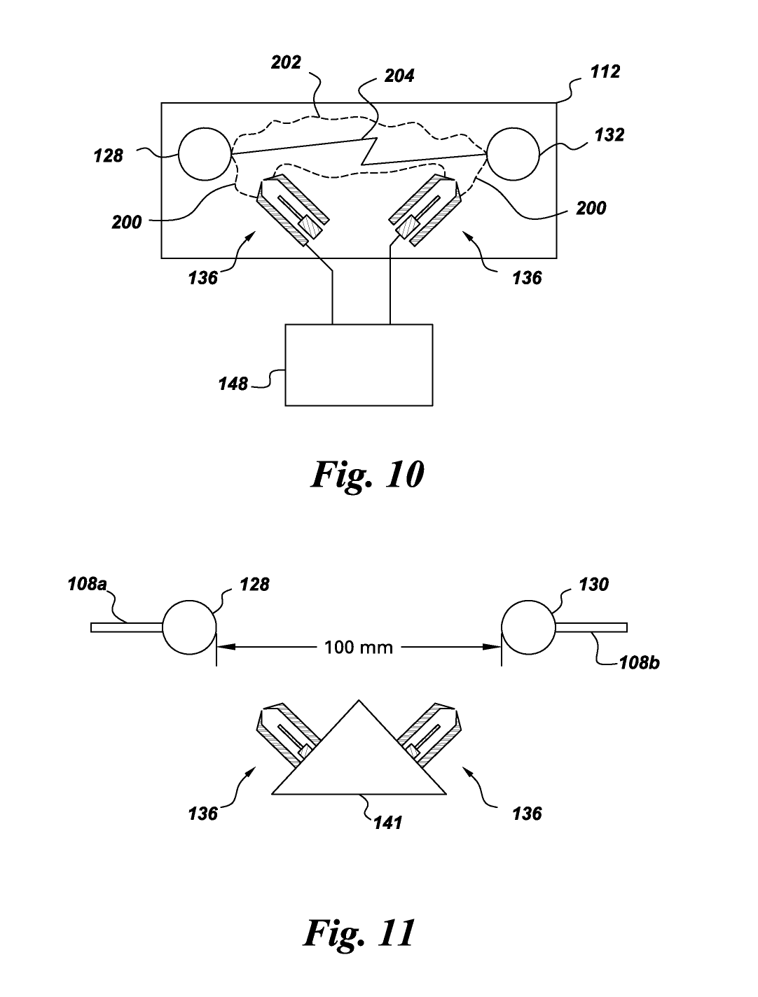

Referring to FIGS. 2, 5 and 8-10, once the arc 198 has been established, the low voltage, high current pulse energy source 148 is configured to maintain a sufficient arc current so as to cause ablation of the associated ablative material portions 152, which results in the generation of plasma 200 in the lumen 144. The plasma 200 can then be emitted from the respective nozzles 147 so as to occupy the space between the main electrodes 128, 130, 132. The plasma 200 can create a conductive plasma bridge 202 between the main electrodes 128, 130, 132, thereby shorting the main electrodes and allowing a protective arc 204 to form therebetween. The plasma bridge 202 may therefore act to mitigate the arc flash event 116, activating a protective device upstream (such as circuit breaker 106) and thereby cutting power supplied to the faulty power system. This deliberately-created fault may be carried out in a controlled manner wherein the energy associated with the arc flash event 116 can be diverted away from the fault location. The protective arc 204 can emit a substantial amount of energy in the form of intense light, sound, pressure waves, and shock waves. The protective arc 204 further causes vaporization of the main electrodes 128, 130, 132, resulting in high pressure. It may be noted that the arc mitigating device 110 can include an enclosure or arc containment device 112 configured to contain shock waves and high pressure resulting from the protective arc 204. Examples of arc containment devices are provided in U.S. patent application Ser. No. 12/471,662 filed on May 26, 2009, which is hereby incorporated by reference in its entirety.

Characteristics of the jet of plasma 200 exiting the nozzles 147, such as velocity, ion concentration, and spread, and also characteristics of the plasma bridge 202, may be controlled by, amongst other things, the dimensions, spacing, and configuration of the plasma guns 136, the type of ablative material, and the manner in which energy is supplied by the energy source 148. Applicants have found that ablative plasma gun embodiments exhibiting coaxial geometry with dimensions in the ranges described above tend to produce plasma jets of enhanced length. The enhanced length may be due to the generation of a sufficient volume of plasma within the gun during an arc flash event and the configuration of the gun so as to efficiently expel the plasma into the surrounding area. Thus, the plasma generation system 134 and the main electrodes 128, 130, 132 can be designed to produce a relatively fast and robust protective arc 204.

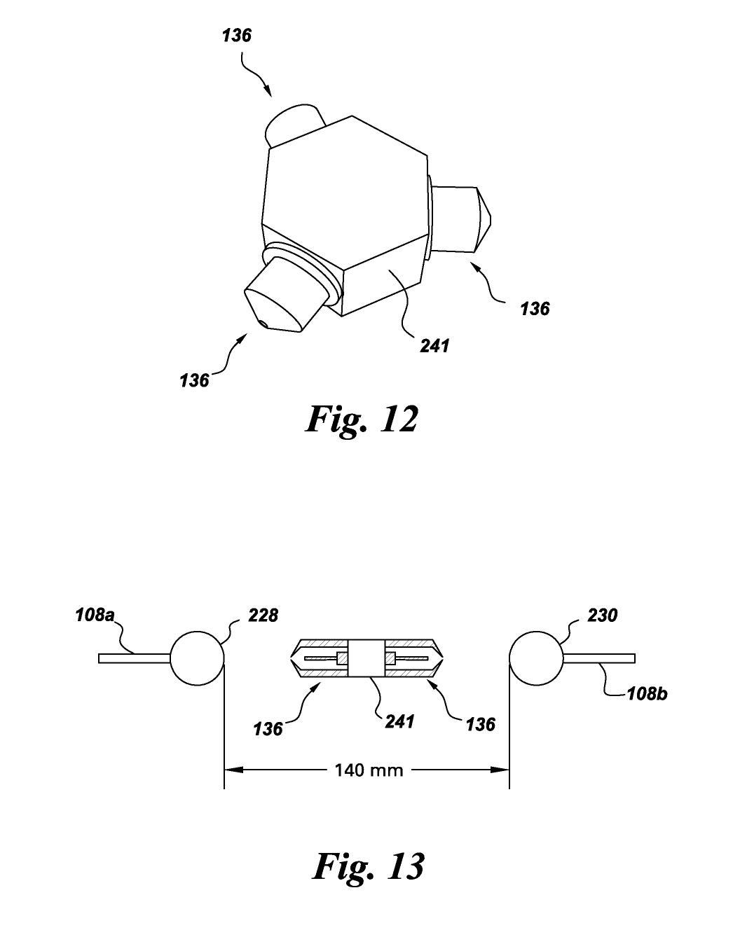

Referring to FIGS. 3 and 11, the configuration of the plasma guns 136 on the housing 141 can be chosen in order to produce a plasma bridge between electrodes 128, 130 that are separated, say, by about 100 mm. Referring to FIGS. 12 and 13, in another embodiment, similar plasma guns 136 can be differently arranged on a housing 241 in order to produce a plasma bridge between electrodes 228, 230 that are separated, say, by about 140 mm. Generally, the plasma guns 136 can be configured such that, when the distance between electrodes is greater, the distance over which the plasma guns direct plasma is increased.

Embodiments configured in accordance with the above examples may facilitate an arc mitigating device for use with an electrical power system configured to handle voltages as high as 17.5 kV, to withstand 110 kV lightning impulses, and to handle 42 kV at power frequency for at least 1 minute. More specifically, embodiments configured in accordance with the above examples may facilitate an arc mitigating device that can produce plasma so as to bridge a gap of 100 mm or more between electrodes.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed:

1. An apparatus comprising:
an annular body that defines a lumen and a longitudinal axis, said annular body having a body length along the longitudinal axis;
an electrode disposed coaxially within the lumen, said electrode extending into said body by an electrode length that is at least about 50% of the body length; and
an ablative material portion disposed between said annular body and said electrode.

2. The apparatus of claim 1, wherein said electrode has diameter less than or equal to about 50% of an inner diameter of said annular body.

3. The apparatus of claim 1, wherein said annular body includes opposing first and second ends and said electrode extends into said annular body from said first end, said apparatus further comprising a nozzle disposed at said second end.

4. The apparatus of claim 1, wherein said annular body and said electrode are configured to be charged as one and the other of a cathode and an anode.

5. The apparatus of claim 1, wherein said annular body and electrode are integrated into a plasma generation device, said apparatus further comprising a main electrode, wherein said plasma generation device is separated from said main electrode by at least about 30 mm and is configured to emit plasma so as to generally occupy a space between said plasma generation device and said main electrode.

6. The apparatus of claim 1, wherein said electrode includes a main region and an initiation region, at least part of said initiation region being disposed closer than said main region to said annular body.

7. The apparatus of claim 1, wherein said ablative material portion is disposed along an inner wall of said annular body.

8. The apparatus of claim 7, wherein said ablative material portion is disposed over about 50% to about 90% of said inner wall.

9. The apparatus of claim 1, further comprising an energy source connected to said annular body and said electrode and configured to sustain an arc between said annular body and said electrode.

10. The apparatus of claim 9, wherein said energy source is configured to produce a voltage less than or equal to about 1 kV and a current of at least about 4 kA.

11. The apparatus of claim 1, wherein said annular body and said electrode are configured such that when an arc exists between said annular body and said electrode, said ablative material portion undergoes ablation.

12. The apparatus of claim 11, wherein said ablative material portion includes an ablative material that is configured so as to generate a plasma when undergoing ablation.

13. The apparatus of claim 11, wherein said ablative material portion includes an ablative material selected from the group consisting of polytetrafluoroethylene, polyoxymethylene polyamide, and poly-methyle methacralate.

14. An apparatus comprising:
a plasma generation device including
an annular body that defines a lumen and a longitudinal axis, said annular body having a body length along the longitudinal axis;
an electrode disposed coaxially within the lumen, said electrode extending into said body by an electrode length that is at least about 50% of the body length; and
an ablative material portion disposed between said annular body and said electrode; and
an energy source connected to said annular body and said electrode and configured to sustain an arc between said annular body and said electrode, wherein said energy source is configured to produce a voltage less than or equal to about 1 kV and a current of at least about 4 kA,
wherein said annular body and said electrode are configured such that when an arc exists between said annular body and said electrode, said ablative material portion undergoes ablation due to the arc and generates a plasma.

15. The apparatus of claim 14, wherein said ablative material portion is disposed along an inner wall of said annular body.

16. The apparatus of claim 14, wherein said electrode has diameter less than or equal to about 50% of an inner diameter of said annular body.

17. The apparatus of claim 14, wherein said annular body includes opposing first and second ends and said electrode extends into said annular body from said first end, said apparatus further comprising a nozzle disposed at said second end.

18. The apparatus of claim 14, wherein said ablative material portion includes an ablative material selected from the group consisting of polytetrafluoroethylene, polyoxymethylene polyamide, and poly-methyle methacralate.

19. The apparatus of claim 14, further comprising a main electrode, wherein said plasma generation device is separated from said main electrode by at least about 30 mm and is configured to emit plasma so as to generally occupy a space between said plasma generation device and said main electrode.

20. The apparatus of claim 14, further comprising a second plasma generation device and two main electrodes that are separated from one another by at least about 50 mm, wherein said plasma generation device and said second plasma generation device are each disposed substantially between said main electrodes and configured to provide a plasma bridge between said main electrodes.
